(19) United States
(12) Patent Application Publication
(10) Pub. No.: US 2026/0178232 A1
(43) Pub. Date: Jun. 25, 2026

(54) STORAGE DEVICE, METHOD OF OPERATING THE STORAGE DEVICE, AND SYSTEM FOR TIME SYNCHRONIZATION-BASED COMMAND SCHEDULING

(71) Applicant: Samsung Electronics Co., Ltd., Suwon-si (KR)

(72) Inventors: Jongin Lee, Suwon-si (KR); Sanghwa Jin, Suwon-si (KR)

(21) Appl. No.: 19/421,704

(22) Filed: Dec. 16, 2025

(30) Foreign Application Priority Data
Dec. 23, 2024 (KR) 10-2024-0194676

(51) Int. Cl. G06F 3/06

(52) U.S. Cl. CPC G06F 3/0659; G06F 3/0604; G06F 3/0679

(57) ABSTRACT

A storage device may include a host interface configured to receive a plurality of submission queues respectively from the plurality of hosts and a memory controller configured to determine priorities of the plurality of submission queues, process the plurality of submission queues according to the priorities, and generate a plurality of completion queues respectively corresponding to the plurality of submission queues, wherein the memory controller receives a plurality of clock signals respectively from the plurality of hosts, generate time synchronization information by synchronizing time between the plurality of hosts and the storage device based on the plurality of clock signals, and determine priorities of the plurality of submission queues, respectively, based on a plurality of pieces of time limit information respectively included in the plurality of submission queues and the time synchronization information.

### CROSS-REFERENCE TO RELATED APPLICATION

This application claims priority under 35 U.S.C. § 119 to Korean Patent Application No. 10-2024-0194676, filed on Dec. 23, 2024, in the Korean Intellectual Property Office, entirety of which is incorporated by reference herein.

### BACKGROUND

Recently, due to a significant increase in the amount of data stored and/or processed by electronic devices including storage devices, there has been a dramatic increase in demand for high-capacity storage devices. Functions related to storage devices are directly related to the stability of systems including the storage devices. This is because, for example, data processed by vehicle systems may include information related to the safety of drivers, and the occurrence of data loss or corruption may affect the safety of the systems.

### SUMMARY

Data loss or corruption may occur when data—such as vehicle system data—fails to be processed within time limits. Therefore, it may be desirable for systems to process data in real time. For example, it may be desirable that control systems in vehicles process and submit data in real time to appropriately control operations of the vehicles based on surrounding environments of the vehicles.

Some aspects of the present disclosure provide storage devices configured to process commands within a time limit required by a host by synchronizing time between the host and the storage device.

According to some implementations of the present disclosure, there is provided a storage device configured to communicate data with a plurality of hosts, the storage device including a host interface configured to receive (i) a plurality of submission queues and (ii) a plurality of clock signals respectively from the plurality of hosts, wherein the plurality of submission queues respectively comprise a plurality of time limit information and a memory controller configured to generate time synchronization information by synchronizing time between the plurality of hosts and the storage device based on the plurality of clock signals, determine respective priorities of the plurality of submission queues based on the plurality of time limit information and the time synchronization information, process the plurality of submission queues in an order that is based on the respective priorities, and generate a plurality of completion queues respectively corresponding to the plurality of submission queues.

According to some implementations of the present disclosure, there is provided a method of operating a storage device, the method including receiving a plurality of submission queues respectively from the plurality of hosts, wherein the plurality of submission queues respectively comprise a plurality of time limit information, receiving a plurality of clock signals respectively from the plurality of hosts, generating time synchronization information by synchronizing time between the plurality of hosts and the storage device based on the plurality of clock signals, and determining respective priorities of the plurality of submission queues based on the time synchronization information and the plurality of time limit information.

According to some implementations of the present disclosure, there is provided a system including a first host configured to generate a first submission queue including a first command and first time limit information indicating a first processing time limit for the first command, a second host configured to generate a second submission queue including a second command and second time limit information indicating a second processing time limit for the second command, and a storage device comprising a host interface configured to receive: the first submission queue a first clock signal the first host, and the second submission queue and a second clock signal from the second host, and, a memory controller configured to: generate time synchronization information by synchronizing time between the first host, the second host, and the storage device based on the first clock signal and the second clock signal, determine a first priority of the first submission queue and a second priority of the second submission queue based on the time synchronization information, the first time limit information, and the second time limit information and, process the first submission queue and the second submission queue in an order that is based on the first priority and the second priority.

### BRIEF DESCRIPTION OF THE DRAWINGS

FIG. 1 is a block diagram illustrating an example of a system;

FIG. 2 is a block diagram illustrating an example of a host;

FIG. 3 is a block diagram illustrating an example of a memory controller;

FIG. 4 is a block diagram illustrating an example of a memory device;

FIG. 5 is a block diagram illustrating an example of a storage device;

FIG. 6 is a diagram illustrating an example of a submission queue;

FIG. 7 is a diagram illustrating an example of a time limit required by a host;

FIG. 8 is a flowchart illustrating an example of a method of operating a storage device;

FIG. 9 is a diagram illustrating an example of a system; and

FIG. 10 is a block diagram illustrating an example of a system including a storage device.

### DETAILED DESCRIPTION

Hereinafter, detailed configurations and structures will be provided to convey an understanding of implementations according to this disclosure. The described examples may be variously modified without departing from the scope of this disclosure.

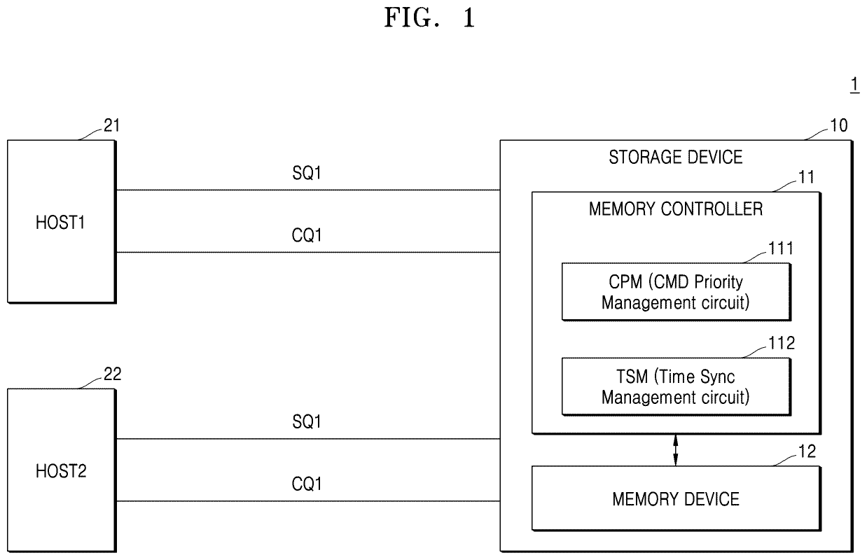

FIG. 1 is a block diagram illustrating an example of a system 1.

Referring to FIG. 1, the system 1 may include a storage device 10, a first host 21, and a second host 22.

The system 1 including two hosts (i.e., the first host 21 and the second host 22) in FIG. 1, is only an example, and the system 1 may include a greater number of hosts. For example, the system 1 may include three or more hosts, and descriptions to be given hereinafter with reference to FIG. 1 may also be applied to a system including three or more hosts.

Regarding communication between the first host 21 and the storage device 10, the system 1 may employ various types of interfaces, and the interfaces may be defined according to suitable protocols or specifications. For example, the system 1 may include various interfaces, e.g., Universal Serial Bus (USB), Multi-Media Card (MMC), Embedded MMC (eMMC), Peripheral Component Interconnection (PCI), PCI-Express (PCI-E), Advanced Technology Attachment (ATA), Serial-ATA, Parallel-ATA, Small Computer System Interface (SCSI), Enhanced Small Disk Interface (ESDI), Integrated Drive Electronics (IDE), FireWire, Nonvolatile Memory Express (NVMe), Universal Flash Storage (UFS), and the like. In addition, the system 1 may employ the aforementioned various interfaces for communication between the second host 22 and the storage device 10.

The storage device 10 may be implemented as a memory that may be embedded to/removable from an electronic device. For example, the storage device 10 may be implemented in various forms, e.g. a UFS memory device, an eMMC, a Solid State Drive (SSD), a UFS memory card, Compact Flash (CF) card, a Secure Digital (SD) card, a Micro Secure Digital (Micro-SD) card, a Mini Secure Digital (Mini-SD) card, an Extreme Digital (xD) card, a memory stick, or the like.

In the following description, the system 1 is described as employing an NVMe interface, and therefore it is assumed that the first host 21 and the storage device 10 generate packets based on protocols of the NVMe interface and communicate with each other. However, the scope of this disclosure is not limited thereto, and other interface types and protocols are within the scope of this disclosure.

In addition, it is also assumed that the second host 22 and the storage device 10 generate packets based on protocols of the NVMe interface and communicate with each other. As described above, the system 1 may include three or more hosts, and the three or more hosts and the system 1 may be configured to transmit and receive data through the NVMe interface.

In the following, it is assumed that the storage device 10 is configured to communicate with the first host 21 and the second host 22 by using Transmission Control Protocol/Internet Protocol (TCP/IP). However, the scope of this disclosure is not limited thereto. As described above, the system 1 may include three or more hosts, and the three or more hosts and the system 1 may be configured to transmit and receive data through TCP/IP.

The storage device 10 may include a memory controller 11 and a memory device 12. As The storage device 10 t may, through the NVMe interface and TCP/IP, receive a first submission queue SQ1 from the first host 21 and receive a second submission queue SQ2 from the second host 22.

The first submission queue SQ1 may include a first command generated by the first host 21. The second submission queue SQ2 may include a second command generated by the second host 22. The memory controller 11 may be configured to process the commands (e.g., the first command and the second command) respectively included in the first submission queue SQ1 and the second submission queue SQ2, and submit completion queues, which include completions indicating that the commands have been completely processed, to the hosts (e.g., the first host 21 and the second host 22).

For example, the memory controller 11 may be configured to receive the first submission queue SQ1, which includes a read command generated by the first host 21, and submit a first completion queue CQ1, which includes a result of processing the read command, to the first host 21. For example, the memory controller 11 may be configured to read data stored in the memory device 12 and submit the first completion queue CQ1, which includes a completion indicating that the reading has ended, to the first host 21. Similarly, the memory controller 11 may be configured to receive the second submission queue SQ2, which includes a write command generated from the second host 22, and submit a second completion queue CQ2, which includes a result of processing the read command, to the second host 22. In the examples described above, for convenience of explanation, it is described that a single submission queue includes only one command, but a single submission queue may also include a plurality of commands.

The memory controller 11 may be configured to control the memory device 12 to read the data stored in the memory device 12 or write data to the memory device 12, in response to the read/write commands from the first host 21 and/or the second host 22. For example, the memory controller 11 may be configured to control write, read, and erase operations on the memory device 12 by providing address, command, and control signals to the memory device 12. In addition, data for programming and data that has been read may be transmitted and received between the memory controller 11 and the memory device 12.

The memory device 12 may include a three-dimensional memory cell array, the three-dimensional memory cell array may include a plurality of NOT-AND (NAND) strings, and the NAND strings may each include a plurality of memory cells respectively connected to a plurality of word lines vertically stacked on a substrate. However, the memory configuration is not limited thereto. In some implementations, a memory cell array may include a two-dimensional memory array, and the two-dimensional memory cell array may include a plurality of NAND strings arranged in row and column directions. However, the memory configuration is not limited thereto, and the memory cell array may include various types of nonvolatile memory cells, e.g., Resistive RAM (ReRAM), Phase-Change RAM (PRAM), or Magnetic RAM (MRAM). Moreover, the memory device 12 may include at least one of volatile memory or non-volatile memory. For example, a volatile memory device may include static RAM (SRAM), dynamic RAM (DRAM), synchronous DRAM (SDRAM), and the like. Non-volatile memory devices maintain stored contents even when power thereof is off. For example, a nonvolatile memory device may include read only memory (ROM), programmable ROM (PROM), electrically programmable ROM (EPROM), electrically erasable and programmable ROM (EEPROM), flash memory, PRAM, MRAM, RRAM, ferroelectric RAM (FRAM), and the like. Flash memory may be classified into NOR type-flash memory and NAND-type flash memory.

In the following description, it is assumed that the memory device 12 includes a nonvolatile memory. However, the memory device 12 is not limited thereto.

The memory controller 11 may include a command (CMD) priority management circuit 111 and a time synchronization management circuit 112.

The time synchronization management circuit 112 may be configured to synchronize time between the first host 21, the second host 22, and the storage device 10. The time synchronization management circuit 112 may be configured to generate time synchronization information by synchronizing the time between the first host 21, the second host 22, and the storage device 10 included in the system 1, according to a Time Sensitive Networking (TSN) method.

The time synchronization management circuit 112 may be configured to receive time information regarding clocks respectively used by the first host 21 and the second host 22. For example, the time synchronization management circuit 112 may be configured to receive the time information regarding the clocks respectively used by the first host 21 and the second host 22 by periodically receiving Precision Time Protocol (PTP) packets submitted through the clocks respectively used by the first host 21 and the second host 22. Here, the time information may include a clock cycle, a latency caused due to a data transmission/reception path, and/or the like. The time synchronization management circuit 112 may be configured to synchronize time between the clocks respectively used by the first host 21 and the second host 22, based on the received time information. The time synchronization management circuit 112 may be configured to generate the time synchronization information, i.e., information regarding the time that has been synchronized.

As described above, the storage device 10 may be configured to receive the first submission queue SQ1 from the first host 21 and receive the second submission queue SQ2 from the second host 22. In addition, as described above, the first submission queue SQ1 may include at least one first command, and the second submission queue SQ2 may include at least one second command.

The first submission queue SQ1 may further include, in addition to the at least one first command, first time limit information regarding the at least one first command. The time limit information may indicate a maximum duration (i.e., a time limit) in which a command is to be processed for appropriate operation of the system 1 or the host. For example, when time limit information about the command transmitted from the host is 300 ms, it may indicate that a time period from the time point at which the host generates the command, to the time point at which the command receives a completion queue, i.e., a response to the commands, is not to exceed 300 ms. When the time period exceeds 300 ms, the host may not receive the completion queues within a time limit and repeatedly generate same commands, and thus, the system 1 may malfunction. Therefore, it is desirable that the commands are processed within the time limit according to the time limit information, for prevention of malfunction and/or for appropriate operation of the system 1 or the hosts included in the system 1.

The CMD priority management circuit 111 may be configured to manage the priorities of the plurality of commands (or schedule the plurality of commands) included in the first submission queue SQ1 and the second submission queue SQ2, based on the time limit information included in each of the first submission queue SQ1 and the second submission queue SQ2 and the time synchronization information. The CMD priority management circuit 111 may be configured to manage the priorities of the plurality of commands such that the plurality of commands may be processed considering time limit for each of the plurality of commands.

The system 1 may include a vehicle system. For example, a vehicle may include the first host 21, the second host 22, and the storage device 10. The vehicle may include various devices configured to transfer objects to be transferred, e.g., a human, an object, or an animal, from a point of departure to a destination. For example, the vehicle may include cars driven on roads or tracks, ships moving on the sea or river, airplanes flying in the sky using aerodynamic effects, and the like. High stability is desirable for vehicle systems configured to transfer the objects to be transferred, and in accordance with development and application of autonomous driving technology such as Advanced Driver Assistance System (ADAS), higher stability has been desirable for vehicle systems. Real-time data generation and/or processing is highly important for the stability of the vehicle systems. For example, accidents may be prevented only when brake systems of autonomous driving vehicles adjust a pressure of brakes of vehicles in real time (e.g., within a time limit) and sensor devices of autonomous driving vehicles process data collected from environments in real time (e.g., within a time limit). As described above, the vehicle system may include a plurality of devices (e.g., the brake device and the sensor device), and it is desirable that the plurality of commands generated by the plurality of devices are processed in real time (e.g., within time limits) for the stability of the vehicle systems. Time limits for the plurality of commands may vary, and therefore, efficient management of the order in which the plurality of commands are processed may be based on the time limits.

In addition, in a shared storage structure where a plurality of devices share a storage device, the number of commands to be processed by the storage device may increase, and therefore, it is desirable to manage the priorities of the plurality of commands in consideration of time limits for the plurality of commands.

The storage device 10 may synchronize the time with the plurality of hosts (e.g., the sensor device and the brake device described above) and manage the priorities such that the commands generated by the plurality of hosts may be processed (e.g., the storage device 10 processes the submission queues) and responded to (e.g., the first host 21 receives the first completion queue) within the time limits.

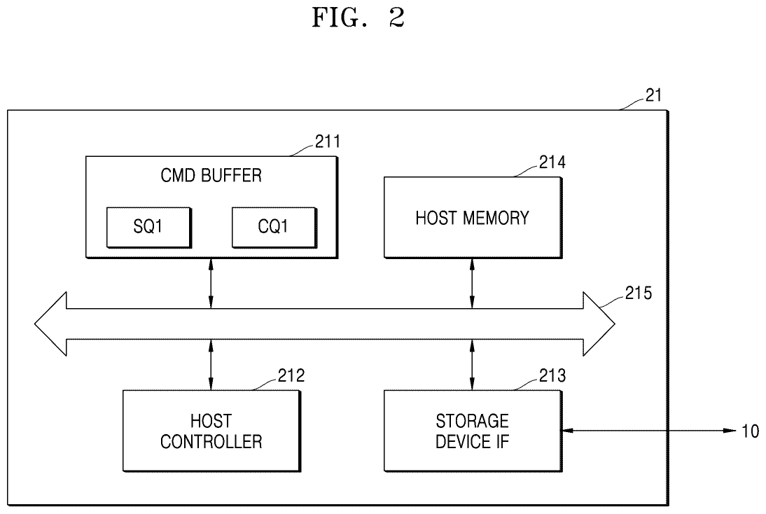

FIG. 2 is a block diagram illustrating an example of a host. For example, FIG. 2 is a diagram illustrating further details of the first host 21 described above with reference to FIG. 1. Accordingly, the same descriptions as given above with reference to FIG. 1 will not be given. Description to be given hereinafter about the first host 21, with reference to FIG. 2, may be applied to each of the plurality of hosts included in the system 1. For example, descriptions to be given hereinafter about the first host 21 with reference to FIG. 2 may be applied to the second host 22.

The first host 21 may include a data processing unit. The first host 21 may be configured to execute an operating system (OS) and/or various applications. For example, the first host 21 may be implemented as a System-On-a-Chip (SoC). The first host 21 may be configured to control a data processing operation on the system 1 (see FIG. 1). The first host 21 may include at least one processor. For example, the first host 21 may also include a multi core processor.

The processor may include a central processing unit (CPU), a digital signal processor (DSP), a graphics processing unit (GPU), an application processor (AP), a communication processor (CP), an encryption processing unit, a physics processing unit, a machine learning processing unit, and the like. The processor may be configured to perform data processing by using a memory.

The first host 21 may include a command buffer 211, a host controller 212, a storage device interface 213, a host memory 214, and a host bus 215. The host bus 215 may include a device for connecting the command buffer 211, the host controller 212, the storage device interface 213, and the host memory 214. The command buffer 211, the host controller 212, the storage device interface 213, and the host memory 214 may communicate with one another.

The host controller 212 may be configured to generate a command. The host controller 212 may generate, in addition to the command, time limit information about the command. The host controller 212 may be configured to generate the first submission queue SQ1. The first submission queue SQ1 may include the command and time limit information about the command generated by the host controller 212. The host controller 212 may be configured to receive the first completion queue CQ1. The first completion queue CQ1 may correspond to the first submission queue SQ1, and may include a completion (or completion data) indicating that the command included in the first submission queue SQ1 has been completely processed, performed, completed, or the like. The time limit information may indicate a time period for an appropriate operation of the first host 21 from the time point which the command is generated to the time point at which the completion queue CQ1, i.e., the response to the command, is received. Accordingly, the time limit information may indicate a time period for an appropriate operation of the host from the time point at which the host generates the command to the time point at which a result of data processing corresponding to the command is received.

The command buffer 211 may include the first submission queue SQ1 and the first completion queue CQ1. Although FIG. 2 illustrates that the first submission queue SQ1 and the first completion queue CQ1 are stored in the command buffer 211, the first submission queue SQ1 may be generated by the host controller 212 and transmitted to the storage device 10 without passing through the command buffer 211. In addition, the first completion queue CQ1 may be received by the host controller 212 without passing through the command buffer 211.

The first host 21 may be configured to communicate with the storage device 10 through the storage device interface 213. In some implementations, as described above, the storage device interface 213 may include an NVMe interface, and the first host 21 may be configured to submit the first submission queue SQ1 including the command and the time limit information and receive the first completion queue CQ1, based on the storage device interface 213. In addition, the first host 21 may be configured to communicate with the storage device 10 by transmitting and receiving packets based on TCP/IP.

The host memory 214 may be configured to store data to be programmed to the storage device 10 or data read from the storage device 10. In addition, software including various programs related to functions of the first host 21 may be loaded into the host memory 214. For example, programs such as OS and file systems may be loaded into the host memory 214. For example, the host memory 214 may be implemented through RAM, ROM, EEPROM, flash memory, or other memory technologies.

The host bus 215 may be configured to operate based on various bus protocols. The various bus protocols may include at least one of Advanced Microcontroller Bus Architecture (AMBA) protocol, USB protocol, PCI protocol, PCI-E protocol, ATA protocol, Serial-ATA protocol, Parallel-ATA protocol, SCSI protocol, ESDI protocol, IDE protocol, Mobile Industry Processor Interface (MIPI) protocol, UFS protocol, Non-Volatile Memory express over Fabrics (NVMe-oF) protocol, and the like.

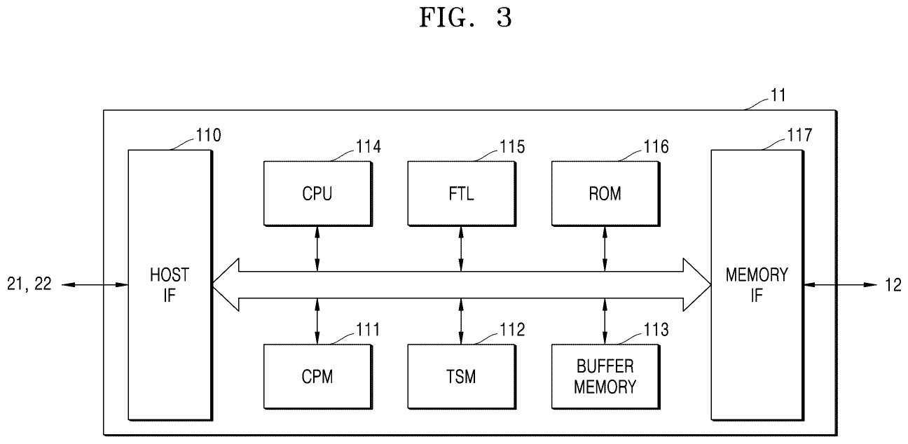

FIG. 3 is a block diagram illustrating an example of the memory controller 11. FIG. 3 may be understood with reference to FIG. 1, and same descriptions are omitted.

The memory controller 11 may include the CMD priority management circuit 111, the time synchronization management circuit 112, a buffer memory 113, a CPU 114, a flash translation layer (FTL) 115, Read Only memory (ROM) 116, a host interface 110, and a memory interface 117.

The CMD priority management circuit 111 may be configured to receive the time synchronization information from a synchronization management circuit to be described below. The CMD priority management circuit 111 may be configured to receive a plurality of commands and time limit information about the plurality of commands from the plurality of hosts (i.e., the first host 21 and the second host 22). The CMD priority management circuit 111 may be configured to manage priorities of the plurality of commands based on the time limit information and the time synchronization information.

As described above, the time limit information may indicate a time period for appropriate operations of the host from a time point at which the host generates the command to a time point at which the host receives the completion queue, i.e., the response to the command. That is, the time limit information may be understood as time limit consumed for processing the command and submitting and receiving the completion queue, i.e., the response for processing of the command. Accordingly, when the host receives the completion queue after the time limit according to the time limit information, the host may not appropriately operate. For example, when the time limit according to the time limit information is not satisfied, the host may determine that the command has not been processed and thus generate a new command, and as this process is repeatedly performed, the host may not appropriately operate.

The CMD priority management circuit 111 may be configured to manage the priorities of the plurality of commands such that each of the plurality of commands may be processed and the completion queues for the commands may be received by the host within the time limit, based on the time limit information for each of the plurality of commands. The storage device may be configured to process the plurality of commands according to the priorities thereof.

The time synchronization management circuit 112 may be configured to synchronize the time between the plurality of hosts (i.e., the first host 21 and the second host 22) and the storage device. The plurality of hosts (i.e., the first host 21 and the second host 22) may use a same clock signal, but may also use different clock signals. Accordingly, the plurality of hosts (i.e., the first host 21 and the second host 22) may generate the commands at different time points by operating in different domains, and the time limit information may differ for each of the commands. Therefore, to manage the priorities of the commands generated by the plurality of hosts (i.e., the first host 21 and the second host 22), by the storage device, it can be useful for the time between the storage device and the plurality of hosts (i.e., the first host 21 and the second host 22) to be synchronized. The time synchronization management circuit 112 may be configured to receive time information and, based on the time information, synchronize the time between the plurality of hosts (i.e., the first host 21 and the second host 22) and the storage device included in the system through a TSN method. Through time synchronization, the storage device may calculate a time point at which the commands are respectively generated from the plurality of hosts (i.e., the first host 21 and the second host 22) and a time point at which the completion queues are received by the hosts. Accordingly, the storage device may manage the commands such that the commands are processed within the time limit based on the time limit information and the completion queues for the commands may be received by the hosts.

The time synchronization management circuit 112 may be configured to receive clocks from the plurality of hosts (e.g., the first host 21 and the second host 22) for time synchronization. The time synchronization management circuit 112 may be configured to perform time synchronization for the plurality of hosts (e.g., the first host 21 and the second host 22) by storing and managing the clocks received from the plurality of hosts. For example, the time synchronization management circuit 112 may be configured to calculate a time latency of the clocks received through a path from the hosts to the storage device, and the storage device may undergo time synchronization with the hosts.

The time synchronization management circuit 112 may be configured to predict network traffic by receiving data submitted by the hosts at an accurate timing, to thereby synchronize the time with the host. The host may be configured to submit the data at the accurate timing by using a switch configured to submit a data frame through a particular time slot.

The time synchronization management circuit 112 may be configured to perform the time synchronization for the plurality of hosts (e.g., the first host 21 and the second host 22) and generate the time synchronization information, e.g., a result of the time synchronization. The time synchronization information may include time domain information for each of the plurality of hosts. The CMD priority management circuit 111 may be configured to receive the time synchronization information and calculate a time point at which the plurality of hosts respectively generate the commands, a latency due to network hop, and/or the like. The CMD priority management circuit 111 may be configured to manage the priorities of the commands in consideration of the time point at which the commands are generated and the latency due to network hop, such that the completion queues corresponding to the commands may be received by the hosts within the time limit.

The buffer memory 113 may be configured to temporarily store data to be written to the memory device 12 or data to be read from the memory device 12. In some implementations, the buffer memory 113 may be provided in the memory controller 11, but the buffer memory 113 may instead or also be arranged outside the memory controller 11. In some implementations, a portion or the entirety of the buffer memory 113 includes a non-volatile memory.

The CPU 114 may be configured to control general operations of the memory device 12. For example, the CPU 114 may be configured to control the memory device 12 to decode the commands received from the plurality of hosts (e.g., the first host 21 and the second host 22) and perform operations according to a result of the decoding. The CPU 114 may be configured to, by executing firmware loaded in the ROM 116, perform garbage collection, address mapping, wear leveling, and the like to manage the memory device 12 in the FTL 115.

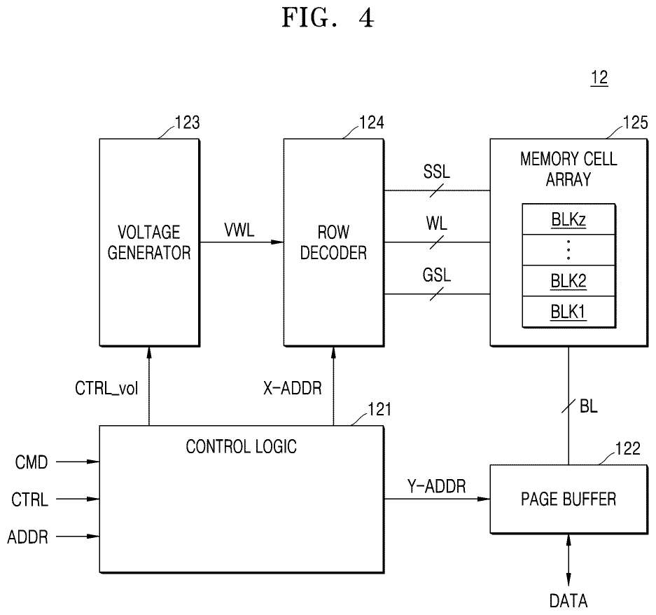

The FTL 115 may be configured to perform various functions such as address mapping, wear leveling, and garbage collection. Address mapping is an operation of converting a logical address, which is received from a host, into a physical address used for actually storing data into the memory device 12. Wear leveling is technology to prevent excessive degradation of a particular memory block by having memory blocks (i.e., memory blocks BLK1 to BLKz in FIG. 4 to be described below) in the memory device 12 be uniformly used, and for example, may be implemented through firmware technology of balancing program/erase counts of physical blocks. Garbage collection is technology to secure an available capacity in the memory device 12 through a method of copying valid data of a memory block to another memory block and erasing the memory block from which the valid data has been copied.

The ROM 116 may include ROM configured to store a program executed by the CPU 114. A program for implementing a method of operating the memory controller 11 or firmware containing the program may be stored in the ROM 116.

The host interface 110 may be configured to transmit/receive packets to/from the plurality of hosts (e.g., the first host 21 and the second host 22). The packets submitted from the plurality of hosts to the host interface 110 may include commands or the data to be written to the memory device 12, and the packets submitted from the host interface 110 to the plurality of hosts may include the responses to the commands or the data read from the memory device 12.

As described above, the host interface 110 may include an NVMe interface. In addition, the packets submitted through the host interface 110 may include packets based on TCP/IP. An NVMe interface may be a high-performance storage interface supporting data transmission and include a high bandwidth and a low latency. In addition, an NVMe interface may be applied to a system having an Ethernet communication structure. The Ethernet communication may have advantages of providing a high data transmission rate, a high bandwidth, and various topologies. Therefore, the memory controller 11 may include the NVMe interface configured to support Ethernet communication and synchronize the time between the plurality of hosts (e.g., the first host 21 and the second host 22), to thereby perform real-time data processing on the commands provided by the plurality of hosts.

The memory interface 117 may be configured to transmit the data, which is to be written to the memory device 12, to the memory device 12, or receive the data read from the memory device 12. The memory interface 117 may be implemented to comply with a standard protocol such as Toggle or Open NAND Flash Interface (ONFI).

FIG. 4 is a block diagram illustrating an example of a memory device. For example, FIG. 4 may illustrate an example of the memory device 12 shown in FIG. 1.

Referring to FIG. 4, the memory device 12 may include a control logic 121, a page buffer 122, a voltage generator 123, a row decoder 124, and a memory cell array 125. The memory device 12 may further include other various elements related to memory operations, e.g., a data input/output circuit and/or an input/output interface.

The control logic 121 may be configured to output various types of internal control signals for programming data to the memory cell array 125 or reading data from the memory cell array 125 in response to commands CMD, addresses ADDR, and control signals CTRL received from the memory controller 11. For example, the control logic 121 may be configured to output a voltage control signal CTRL_vol for controlling levels of various voltages generated by the voltage generator 123. The control logic 121 may be configured to provide a row address X-ADDR to the row decoder 124 and provide a column address Y-ADDR to the page buffer 122.

The page buffer 122 may be configured to operate in response to control of the control logic 121. For example, the page buffer 122 may be configured to operate as a write driver or a sense amplifier. In some implementations, in a program operation, the page buffer 122 may operate as the write driver and apply, to bit lines BL, a voltage according to data DATA to be stored in the memory cell array 125. In some implementations, in a write operation, the page buffer 122 may operate as the sense amplifier and sense the data DATA stored in the memory cell array 125.

The voltage generator 123 may be configured to generate various voltages used in the memory device 12. For example, the voltage generator 123 may generate, as a word line voltage VWL, a program voltage, a read voltage, a program verification voltage, an erase voltage, and/or the like.

The row decoder 124 may be configured to select at least one of the word lines in a memory block selected in response to the row address X-ADDR.

The memory cell array 125 may include a plurality of memory cells, and may be connected to word lines WL, string selection lines SSL, ground selection lines GSL, and bit lines BL. The memory cell array 125 may be connected to the row decoder 124 through the word lines WL, the string selection lines SSL, and the ground selection lines GSL, and may be connected to the page buffer 122 through the bit lines BL.

For example, the plurality of memory cells included in the memory cell array 125 may include nonvolatile memory cells in which stored data is maintained when power supplied to the memory cells is interrupted. More particularly, when the plurality of memory cells include nonvolatile memory cells, the memory device 12 may include EEPROM, flash memory, PRAM, RRAM, Nano Floating Gate Memory (NFGM), Polymer Random Access Memory (PoRAM), MRAM, FRAM, or the like. Hereinafter, description will be provided with reference to an example where the plurality of memory cells include NAND flash memory cells, but it will be understood that the memory configuration is not limited thereto.

The memory cell array 125 may include a plurality of memory blocks BLK1 to BLKz, each of which may have a planar structure or a three-dimensional structure. The memory cell array 125 may include at least one of a single level cell block including single level cells (SLC), a multi-level cell block including multi-level cells (MLC), a triple level cell block including triple level cells (TLC), and a quad level cell block including quad level cells (QLC). For example, some of the plurality of memory blocks BLK1 to BLKz may include single level cell blocks, and the other memory blocks may include multi-level cell blocks, triple level cell blocks, and quad level cell blocks.

As described above, the storage device may be configured to control real-time processing on the plurality of commands by managing priorities of processing the commands CMD described above with reference to FIG. 4.

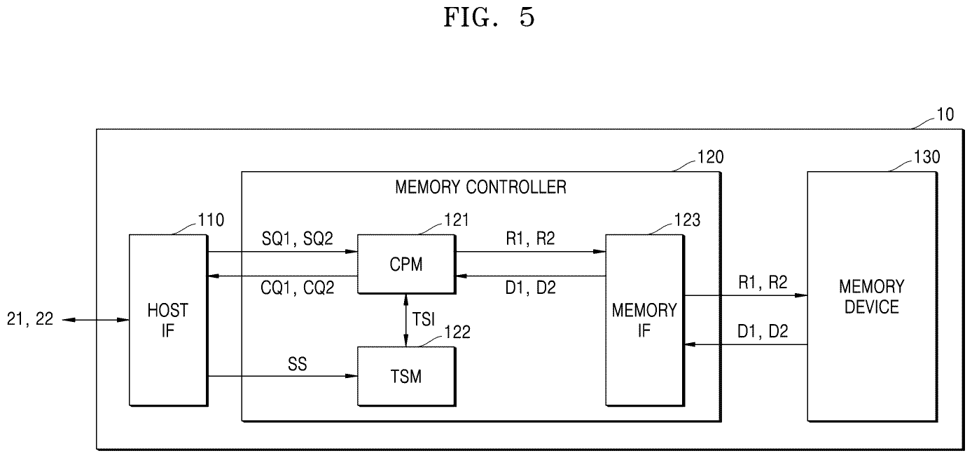

FIG. 5 is a block diagram illustrating an example of a storage device. FIG. 5 may be understood with reference to FIGS. 1, 2, and 3. FIG. 5 is provided for further describing operations of the memory controller 11 illustrated in FIG. 3. Therefore, the same descriptions as those given above will not be repeated.

Referring to FIG. 5, the storage device 10 may include the memory controller 11 and the memory device 12, as described above with reference to FIG. 3. The memory controller 11 may include the CMD priority management circuit 111, the time synchronization management circuit 112, the host interface 110, and the memory interface 117. For convenience of description, FIG. 5 illustrates that the memory controller 11 includes the host interface 110 and the memory interface 117, but interface configuration is not limited thereto.

As described above, the host interface 110 may include an NVMe interface. In addition, the packets submitted through the host interface 110 may include packets based on TCP/IP. An NVMe interface may be a high-performance storage interface supporting data transmission and may provide a high bandwidth and a low latency. In addition, an NVMe interface may be applied to a system having an Ethernet communication structure. The Ethernet communication may have advantages of providing a high data transmission rate, a high bandwidth, and various topologies. Therefore, the memory controller 11 may include the NVMe interface configured to support Ethernet communication, and may synchronize the time between the plurality of hosts (e.g., the first host 21 and the second host 22) and the storage device 10, to thereby perform real-time data processing on the commands provided by the plurality of hosts. However, as noted above, the scope of the present disclosure is not limited to the NVMe interface and TCP/IP.

Through the host interface 110, the memory controller 11 may receive the first submission queue SQ1 including at least one first command from the first host 21 and receive the second submission queue SQ2 including at least one second command from the second host 22. As described above, the memory controller 11 may be configured to receive submission queues respectively from three or more hosts.

As described above, the submission queue may include the command and the time limit information about the command. For example, the first submission queue SQ1 may include the first command and first time limit information that are generated by the first host 21. Similarly, the second submission queue SQ2 may include the second command and second time limit information that are generated by the second host 22.

The time synchronization management circuit 112 may be configured to receive a synchronization signal SS from the host. The synchronization signal SS may include the clock signals of the plurality of hosts (e.g., the first host 21 and the second host 22). The time synchronization management circuit 112 may be configured to synchronize the time between the plurality of hosts respectively using different domains, by storing and managing the clock signals of the plurality of hosts. The time synchronization management circuit 112 may be configured to generate time synchronization information TSI by synchronizing the time between the plurality of hosts based on the synchronization signal SS. The time synchronization information TSI may include information about the clock signals used by the hosts. The time synchronization information TSI may include information about latencies until the plurality of submission queues are respectively delivered from the plurality of hosts to the storage device 10 and time points at which the plurality of submission queues are respectively generated. The storage device may be configured to schedule the plurality of submission queues (e.g., the first submission queue SQ1 and the second submission queue SQ2) based on the time synchronization information TSI described above.

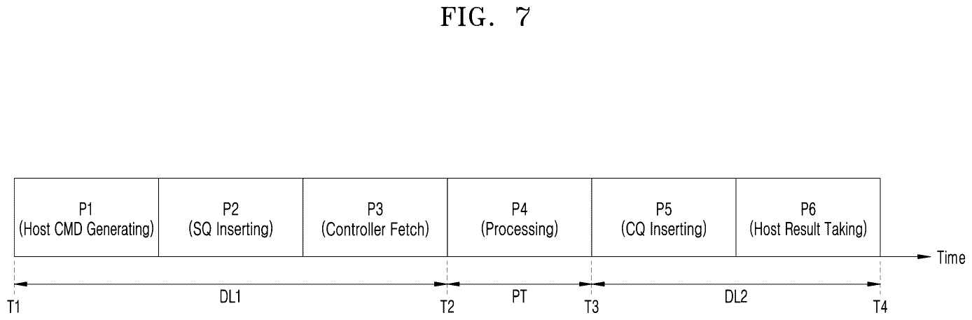

The CMD priority management circuit 111 may be configured to calculate the time point at which the hosts generate commands and the latency caused by network hop and/or other effects, based on the time synchronization information TSI. The CMD priority management circuit 111 may be configured to calculate a first latency DL1 (see FIG. 7) and a second latency (see FIG. 7) described below with reference to FIG. 7, based on the time synchronization information TSI. The first latency DL1 may indicate a time period from the time point at which the commands are generated to a time point at which the submission queues are fetched by a controller (e.g., the memory controller 11), and the second latency DL2 may indicate a time period from a time point at which the completions generated in response to the command processing to a time point at which the hosts receive the completion queues. The CMD priority management circuit 111 may be configured to calculate a maximum time period that may be allocated for command processing, based on the latency calculated based on the time synchronization information TSI and the time limit information. The CMD priority management circuit 111 may be configured to manage the priorities of the plurality of commands based on the maximum time period that may be allocated for command processing.

As described above, the commands respectively generated from the plurality of hosts (e.g., the first host 21 and the second host 22) may have different pieces of time limit information. In addition, a time period (the latency) consumed for transmitting and receiving the commands and/or transmitting the responses to the commands may be different. Accordingly, the storage device 10 may be configured to manage timings to process the plurality of commands such that the plurality of commands may be processed within a time limit based on management on the priorities of the commands according to time synchronization with the plurality of hosts and the time limit information.

Referring to FIG. 5, the memory controller 11 may be configured to receive the first submission queue SQ1 and the second submission queue SQ2 from the plurality of hosts (e.g., the first host 21 and the second host 22) through the host interface 110. The time synchronization management circuit 112 may be configured to generate the time synchronization information TSI by receiving the synchronization signal SS and synchronizing the time between the storage device 10 and the plurality of hosts. The CMD priority management circuit 111 may be configured to receive the first submission queue SQ1 and the second submission queue SQ2 and manage the priorities of the first command included in the first submission queue SQ1 and the second command included in the second submission queue SQ2 based on the first time limit information included in the first submission queue SQ1, the second time limit information included in the second submission queue SQ2, and the time synchronization information TSI. The memory controller 11 may be configured to deliver a first request R1 in response to the first command and a second request R2 in response to the second command to the memory device 12 through the memory interface 117, to thereby process the first request R1 and the second request R2 based on the priorities. Here, the first request R1 and the second request R2 may respectively include the control signals CTRL (see FIG. 4) and the addresses ADDR (see FIG. 4) according to the first command and the second command. However, the first request R1 and the second request R2 are not limited thereto. The memory device 12 may be configured to receive the first request R1 and the second request R2, receive and process the first command and the second command according to the priorities, and transmit first data D1 and second data D2 to the memory controller 11. The aforementioned operations of the memory device 12 may be understood based on the descriptions given above with reference to FIG. 4.

The memory controller 11 may be configured to receive the first data D1 and the second data D2 through the memory interface 117. The memory controller 11 may be configured to receive the first data D1, which corresponds to processing on the first command, and generate the first completion queue CQ1, i.e., a response for the first command. The first completion queue CQ1 may include a first completion (or first completion data) that is a response for the first command. Similarly, the memory controller 11 may be configured to receive the second data D2, which corresponds to processing on the second command, and generate the second completion queue CQ2, i.e., a response for the second command. The second completion queue CQ2 may include a second completion (or second completion data) that is a response for the second command. The memory controller 11 may be configured to deliver the first completion queue CQ1 and the second completion queue CQ2 to the plurality of hosts through the host interface 110. For example, the memory controller 11 may be configured to deliver the first completion queue CQ1 to the first host 21 and deliver the second completion queue CQ2 to the second host 22. For convenience of description, FIG. 5 illustrates that the first completion queue CQ1 and the second completion queue CQ2 are generated and transmitted by the CMD priority management circuit 111, but generations of the completion queues is not limited thereto, and the first completion queue CQ1 and the second completion queue CQ2 may be generated by other elements included in the memory controller 11.

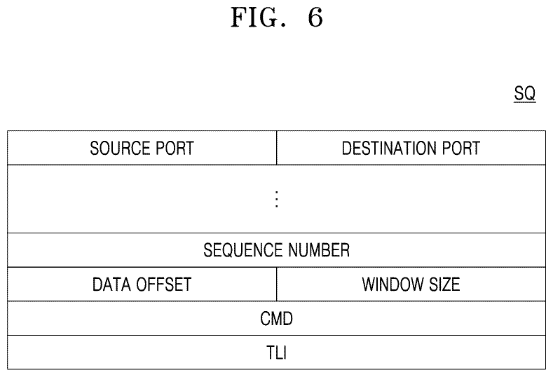

FIG. 6 is a diagram illustrating an example of a submission queue SQ.

Referring to FIG. 6, the submission queue SQ may include Source Port, Destination Port, Sequence Number, Data Offset, Window Size, command CMD, and time limit information TLI.

The Source Port may indicate a host by which the command CMD is generated, the Destination Port may indicate a destination to which the command CMD is to be submitted, and the Sequence Number may indicate the order of submitted data. For example, when the submission queue SQ includes a plurality of commands CMD, the Sequence Number may indicate the order of a command. The Data Offset may indicate a position at which data starts, and the Window Size may indicate the size of data that may be submitted at once.

The time limit information TLI may indicate a time limit from the time point at which the commands are generated to the time point at which the submission queues corresponding to the commands are received by the hosts. The submission queue SQ may include packets based on PTP.

FIG. 7 is a diagram for describing an example of time limit information provided by or requested by the host. FIG. 7 may be understood with reference to the descriptions given above with respect to FIG. 1 to FIG. 6, and same descriptions will not be repeatedly given.

FIG. 7 indicates a time period consumed from a first time point T1, at which a command is generated, to a fourth time point T4 at which the host receives a completion queue. As described above, for appropriate operations of the host, it is desirable that the command is processed within the time limit according to the time limit information, and the completion queue is received by the host within the time limit. That is, for appropriate operations of the host, it is desirable that operations included in a first period P1 to a sixth period P6 are performed within the time limit.

In the first period P1, the host may generate the command. In the second period P2, the host may insert the generated command into the submission queue. In the third period P3, the submission queue may be fetched by a controller (e.g., a memory controller). In the fourth period P4, the command included in the submission queue may be processed by the controller. In the fifth period P5, the controller may insert a completion, which is a response for command processing, into a completion queue. In the sixth period P6, the controller may transmit the completion queue to the host, and the host may receive the completion queue.

As described above, the storage device may be configured to perform time synchronization between the plurality of hosts. Therefore, the storage device may calculate the first latency DL1 and the second latency DL2. The first latency DL1 may indicate a time period from the time point T1, at which the command is generated, to the time point T2 at which the submission queue is fetched by the controller. The second latency DL2 may indicate a time period from which the time point T3, at which the completion generated in response to command processing is inserted into the completion queue, to a time point T4 at which the host receives the completion queue.

For example, referring to elements shown in FIG. 5, the time synchronization management circuit 112 may be configured to generate the time synchronization information TSI by synchronizing the time between the plurality of hosts and the storage device through the TSN method. The CMD priority management circuit 111 may be configured to receive the time synchronization information TSI and calculate the first latency DL1 and the second latency DL2 based on the time synchronization information TSI. The storage device may be configured to perform time synchronization with the host and calculate the first latency DL1 and the second latency DL2 based on the time synchronization. The storage device may determine a time period, which remains after subtracting the first latency DL1 and the second latency DL2 from the time limit according to the time limit information, as a command-processing time PT. The storage device may be configured to manage the priorities of processing the plurality of commands based on the command-processing time PT that has been determined. The storage device, instead of the host, may manage the priorities of the plurality of commands, and may process the plurality of commands in real time. The command-processing time PT may correspond to a difference between the time limit according to the time limit information and the latency consumed for transmitting and receiving the queue, e.g., latency as discussed with respect to FIG. 7. For example, the command-processing time PT may correspond to a difference between the time limit according to the time limit information, the time period consumed for transmitting and receiving the submission queue, and the time period consumed for transmitting and receiving the completion queue.

As described above, the command-processing time PT may vary according to commands. For example, a latency consumed by the storage device to receive the first submission queue generated from the first host may be different from a latency consumed by the storage device to receive the second submission queue generated from the second host. In addition, time limit information included in the first submission queue may be different from time limit information included in the second submission queue. Accordingly, the command-processing time PT may vary according to commands, and the storage device may be configured to determine the priorities of command processing in consideration of the command-processing time PT corresponding to each of the plurality of commands.

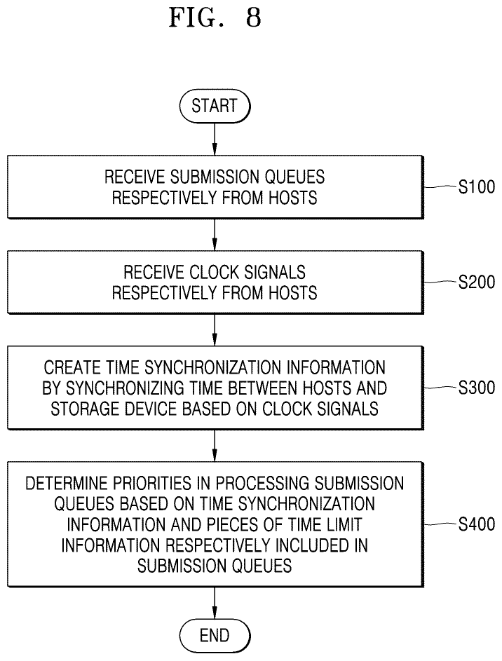

FIG. 8 is a flowchart illustrating an example of a method of operating a storage device, such as the storage device 10.

Referring to FIG. 8, in S100, the storage device may receive a plurality of submission queues respectively from the plurality of hosts.

In S200, the storage device may receive a plurality of clock signals respectively from the plurality of hosts.

In S300, the storage device may generate the time synchronization information by synchronizing the time between the plurality of hosts and the storage device based on the plurality of clock signals. The storage device may be configured to generate the time synchronization information by synchronizing the times between the plurality of hosts and the storage device through the TSN method based on the plurality of clock signals. The time synchronization information may include the information about latencies until the plurality of submission queues are respectively transmitted from the plurality of hosts to the storage device and time points at which the plurality of submission queues are respectively generated.

In S400, the storage device may determine the priorities of processing the plurality of submission queues based on the time synchronization information and a plurality of pieces of time limit information respectively included in the plurality of submission queues.

The priorities may include or indicate an order in which to process the plurality of submission queues. The priorities may be determined such that the time limits provided by the plurality of hosts are satisfied.

The system may include the first host, and the first host may be configured to generate the first submission queue. The first submission queue may include the first time limit information. The storage device may be configured to calculate, based on the time synchronization information, a first latency from the time point at which the first submission queue is generated to the time point at which the first submission queue is received by the storage device. In addition, the storage device may be configured to calculate, based on the time synchronization information, a second latency from a time point at which the first completion queue corresponding to the first submission queue is generated, to a time point at which the first completion queue is received by the first host. The storage device may determine the priority of the first submission queue based on a first processing time period, i.e., a difference between the first time limit according to the first time limit information and a sum of the first latency and the second latency. Similar to the descriptions given above, a second processing time period may be calculated form the second submission queue generated from the second host, and the storage device may be configured to determine the priorities of the first submission queue and the second submission queue by comparing the first processing time period with the second processing time period. For example, based on the first processing time period being less than the second processing time period, the storage device may determine that the first submission queue has a higher priority than the second submission queue, and, correspondingly, the storage device may process the first submission queue before processing the second submission queue.

The storage device may be configured to generate a plurality of completion queues corresponding to the plurality of submission queues by processing the plurality of submission queues according to the priorities. The storage device may be configured to transmit the plurality of completion queues to corresponding hosts. The plurality of submission queue and the plurality of completion queues may each include a data packet according to TCP/IP. The plurality of submission queues and the plurality of completion queues may be transmitted and received between the plurality of hosts and the storage device through the NVMe interface.

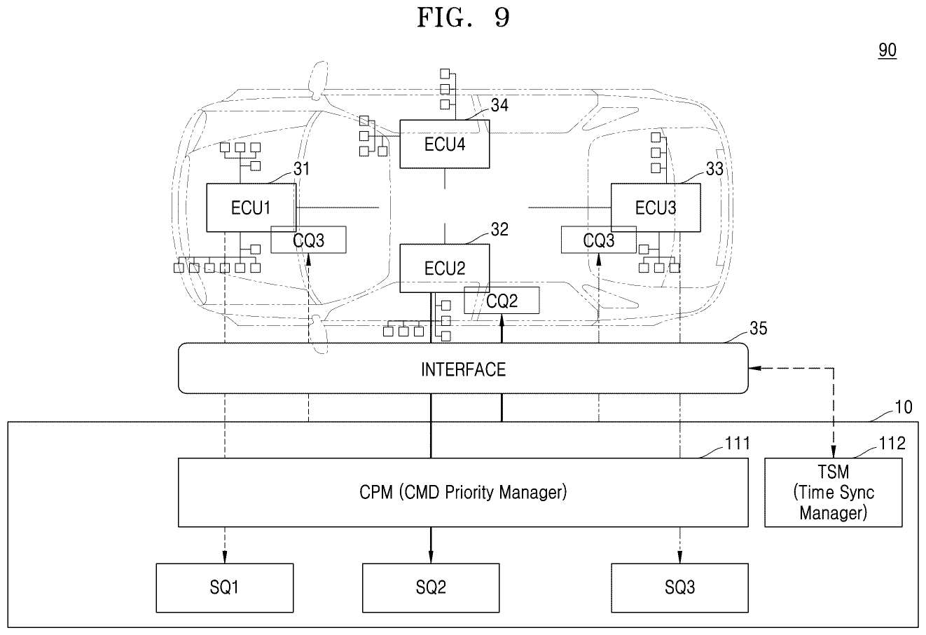

FIG. 9 is a diagram illustrating an example of a system. The system 1 described above with reference to FIGS. 1 to 8 may include a vehicle system 90 illustrated in FIG. 9. Therefore, the same descriptions as those given above will not be repeatedly given.

Referring to FIG. 9, the vehicle system 90 may include a first electronic control unit (ECU) 31, a second ECU 32, a third ECU 33, a fourth ECU 34, an interface 35, and the storage device 10. The first ECU 31, the second ECU 32, the third ECU 33, and the fourth ECU 34 may respectively correspond to the hosts described above and generate commands to perform different functions. For example, the first ECU 31 may include a brake device, the second ECU 32 may include a sensor, and the third ECU 33 may include an infotainment device. The first ECU 31 may be configured to generate the first command and deliver the first submission queue SQ1, which includes the first command, to the storage device 10 through the interface 35. Similarly, the second ECU 32 may be configured to generate the second command and deliver the second submission queue SQ2, which includes the second command, to the storage device 10 through the interface 35. In addition, the third ECU 33 may be configured to generate a third command and deliver a third submission queue SQ3, which includes the third command, to the storage device 10 through the interface 35. Here, the interface 35 may include an NVMe interface, and the submission queues (i.e., the first submission queue SQ1, the second submission queue SQ2, and the third submission queue SQ3) may include packets according to TCP/IP.

An interface between the ECUs included in the vehicle system may be implemented as a Controller Area Network (CAN) or a Local Interconnect Network (LIN). However, the CAN and the LIN have relatively slow transmission rates, and thus may be limited when a high-capacity data submission or high-speed communication is desired. In addition, the CAN and the LIN have limited bandwidths, and thus may be limited when it is required that a plurality of devices simultaneously communicate with each other. Furthermore, the CAN and the LIN only support particular topologies, and thus may be limited compared to physically constructing a network.

In some implementations, as described above, the NVMe interface may be applied to a system having the Ethernet communication structure, and the Ethernet communication may have an advantage of providing a high data transmission rate, a high bandwidth, and various topologies. For convenience of description, FIG. 9 illustrates that the interface 35 is located outside the storage device 10, but the interface configuration is not limited thereto, and the interface 35 may be located in the storage device 10, as illustrated in FIG. 5. In addition, for convenience of description, it is illustrated as though the storage device 10 is located outside the vehicle system, but it will be clearly understood according to the description given above that the vehicle system 90 includes the storage device 10.

The storage device 10 may include the CMD priority management circuit 111 and the time synchronization management circuit 112. Descriptions about the operations of the CMD priority management circuit 111 and the time synchronization management circuit 112 are the same as or similar to the descriptions given above, and thus will not be repeatedly given.

As described above, the storage device 10 may be configured to manage the submission queues received from the hosts through the time synchronization with the hosts. For example, the order of processing the commands included in the submission queues generated by the hosts may be managed by the storage device 10, instead of the hosts. The storage device 10 may process a plurality of commands received from the plurality of hosts within a time limit and submit responses to the plurality of commands to the host (i.e., submit the first completion queue CQ1, the second completion queue CQ2, and the third completion queue CQ3), thereby processing the data in real time. The stability of the vehicle system 90 may be improved through real-time data processing.

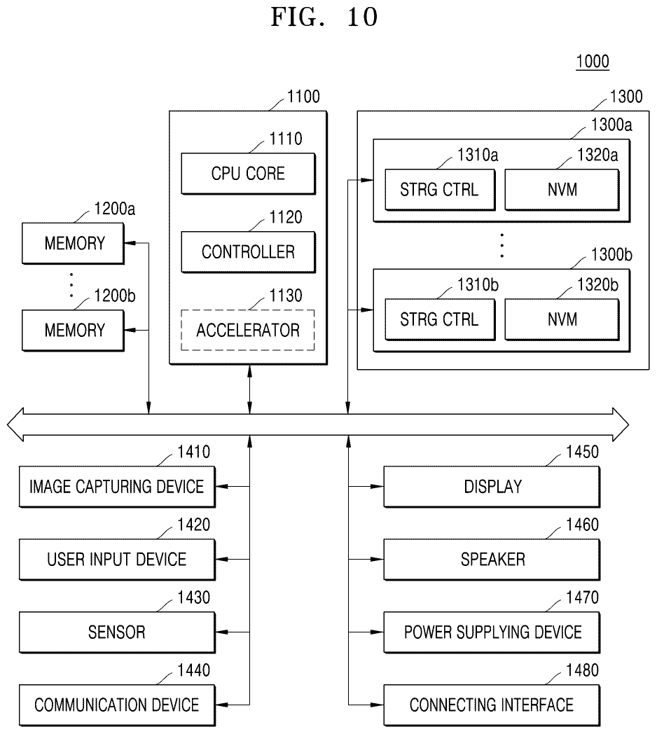

FIG. 10 is a block diagram an example of a system 1000.

The system 1000 illustrated in FIG. 10 may include mobile systems such as mobile phones, smartphones, tablet personal computers (PCs), wearable devices, healthcare devices, or Internet of Things (IoT) devices. However, the system 1000 illustrated in FIG. 10 is not necessarily limited to the mobile system, and may also include PCs, laptop computers, servers, media players, or automotive devices such as navigation systems. In addition, the system 1000 may also include the vehicle system 90 (see FIG. 9), as described above with reference to FIG. 9.

Referring to FIG. 10, the system 1000 may include a main processor 1100, a memory 1200, a memory 1200b, and a storage system 1300, and may additionally include at least one of an image capturing device 1410, a user input device 1420, a sensor 1430, a communication device 1440, a display 1450, a speaker 1460, a power supplying device 1470, and a connecting interface 1480. Here, elements included in the system 1000 illustrated in FIG. 10, i.e., the main processor 1100, the memory 1200a, the memory 1200b, the storage system 1300, the image capturing device 1410, the user input device 1420, the sensor 1430, the communication device 1440, the display 1450, the speaker 1460, the power supplying device 1470, and the connecting interface 1480, may each be implemented using the examples described with reference to FIGS. 1 to 9.

The main processor 1100 may be configured to control general operations of the system 1000, and more particularly, operations of other elements included in the system 1000. The main processor 1100 may be implemented as a general-purpose processor, a dedicated processor, an AP, or the like.

The main processor 1100 may include one or more CPU cores 1110, and may further include a controller 1120 configured to control the memory 1200a, the memory 1200b, and/or the storage system 1300. In some implementations, the main processor 1100 may further include an accelerator 1130, i.e., a dedicated circuit for rapid data computation. The accelerator 1130 may include a GPU, a neural processing unit (NPU), a data processing unit (DPU), and/or the like, and may be implemented as an individual chip that is physically independent of other elements in the main processor 1100.

The memory 1200a and the memory 1200b may be used as a main memory of the system 1000, and may include volatile memory such as SRAM and/or DRAM, but may also include nonvolatile memory such as flash memory, PRAM, RRAM, and/or the like. The memory 1200a and the memory 1200b may also be implemented in a same package with the main processor 1100.

The storage system 1300 may include a plurality of storage devices. For example, the storage system 1300 may include a storage device 1300a and a storage device 1300b. Regardless of power supply, the storage device 1300a and the storage device 1300b may function as nonvolatile storage devices configured to store data, and may have a storage capacity relatively greater than storage capacities of the memory 1200a and the memory 1200b. The storage device 1300a and the storage device 1300b may respectively include a memory controller 1310a and 1310b, and may respectively further include a non-volatile memory (NVM) 1320a and an NVM 1320b configured to store data under control of the memory controller 1310a and the memory controller 1310b. The NVM 1320a and the NVM 1320b may include flash memories having a two-dimensional (2D) or a three-dimensional (3D) structure, but may also include other types of nonvolatile memories, e.g., PRAM and/or RRAM.

As described above, the storage device 1300a and the storage device 1300b may be configured to manage the priorities of the commands received from the plurality of hosts, and within the time limit, process the commands and submit responses for the command processing to the hosts. In FIG. 10, the image capturing device 1410, the user input device 1420, the sensor 1430, the communication device 1440, the display 1450, the speaker 1460, and the power supplying device 1470 may each correspond to the aforementioned host. In addition, as described above, an interface between the plurality of hosts and the storage devices (e.g., the storage device 1300a and 1300b) may include an NVMe interface, and queues transmitted and received by the hosts and the storage devices (i.e., the storage device 1300a and the storage device 1300b) may include packets based on TCP/IP.

The storage system 1300 may be included in the system 1000 as physically separate from the main processor 1100, or may be implemented in a same package with the main processor 1100. In addition, the storage system 1300 may have the form of an SSD or a memory card, and thus may be removably coupled to the other elements in the system 1000 through an interface like a connecting interface 1480 to be described later. The storage system 1300 may include a device to which a standard protocol such as UFS is applied, but is not limited thereto.

The image capturing device 1410 may be configured to capture still images or videos, and may include a camera, a camcorder, a webcam, and/or the like.

The user input device 1420 may be configured to receive various types of data input from a user of the system 1000, and may include a touch pad, a keyboard, a mouse, and/or a microphone.

The sensor 1430 may be configured to sense various physical quantities that may be obtained from the outside of the system 1000 and convert the sensed physical quantities into electrical signals. The sensor 1430 may include a temperature sensor, a pressure sensor, a light sensor, a position sensor, an acceleration sensor, a biosensor, and/or a gyroscope sensor.

The communication device 1440 may be configured to perform transmission and reception of signals with other devices outside the system 1000, according to various communication protocols. The communication device 1440 may be implemented by including an antenna, a transceiver, and/or a MOdulator and DEModulator (MODEM).

The display 1450 and the speaker 1460 may function as output devices configured to respectively output visual information and auditory information to the user of the system 1000.

The power supplying device 1470 may be configured to appropriately convert power provided from a battery (not shown) embedded in the system 1000 and/or an external power source and supply the converted power to elements of the system 1000.

The connecting interface 1480 may be connected to the system 1000 and provide connection between the system 1000 and an external device configured to transmit/receive data to/from the system 1000. The connecting interface 1480 may be implemented in various interface methods, e.g., ATA, Serial ATA (SATA), external SATA (e-SATA), SCSI, Serial Attached SCSI (SAS), PCI, PCIe, NVMe, IEEE 1394, USB, SD card, MMC, eMMC, UFS, eUFS, CF, and card interface.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While certain examples have been particularly shown and described, it will be understood that various changes in form and details may be made therein without departing from the spirit and scope of this disclosure.

What is claimed is:

1. A storage device configured to communicate data with a plurality of hosts, the storage device comprising:
a host interface configured to receive (i) a plurality of submission queues and (ii) a plurality of clock signals respectively from the plurality of hosts,
wherein the plurality of submission queues respectively comprise a plurality of time limit information; and
a memory controller configured to:
generate time synchronization information by synchronizing time between the plurality of hosts and the storage device based on the plurality of clock signals,
determine respective priorities of the plurality of submission queues based on the plurality of time limit information and the time synchronization information,
process the plurality of submission queues in an order that is based on the respective priorities, and
generate a plurality of completion queues respectively corresponding to the plurality of submission queues.

2. The storage device of claim 1, wherein the memory controller is configured to synchronize the time between the plurality of hosts and the storage device through a Time-Sensitive Network (TSN) method, based on the plurality of clock signals.

3. The storage device of claim 1, wherein the host interface comprises a Non-Volatile Memory Express (NVMe) interface.

4. The storage device of claim 3, wherein the plurality of submission queues comprise data packets according to Transmission Control Protocol (TCP)/Internet Protocol (IP).

5. The storage device of claim 1, wherein the plurality of hosts comprise a first host, the plurality of submission queues comprise a first submission queue generated by the first host, and the first submission queue comprises first time limit information, and
the memory controller is configured to, based on the time synchronization information:
determine a first latency from a time point at which the first submission queue is generated to a time point at which the first submission queue is received by the memory controller, based on the time synchronization information, and
determine a second latency from a time point at which a first completion queue corresponding to the first submission queue is generated, to a time point at which the first completion queue is received by the first host.

6. The storage device of claim 5, wherein the memory controller is configured to determine a priority of the first submission queue based on a first processing time period that is a difference between:
a first time limit indicated by the first time limit information, and
a sum of the first latency and the second latency.

7. The storage device of claim 6, wherein the plurality of hosts comprise a second host, the plurality of submission queues comprise a second submission queue generated by the second host, and the second submission queue comprises second time limit information, and
the memory controller is configured to:
determine, based on the time synchronization information, a third latency from a time point at which the second submission queue is generated to a time point at which the second submission queue is received by the memory controller,
determine, based on the time synchronization information a fourth latency from a time point at which a second completion queue corresponding to the second submission queue is generated to a time point at which the second completion queue is received by the second host, determine a second processing time period that is a difference between:
a second time limit indicated by the second time limit information, and
a sum of the third latency and the fourth latency, and
determine respective priorities of the first submission queue and the second submission queue by comparing the first processing time period with the second processing time period.

8. A method of operating a storage device configured to communicate data with a plurality of hosts, the method comprising:
receiving a plurality of submission queues respectively from the plurality of hosts, wherein the plurality of submission queues respectively comprise a plurality of time limit information;
receiving a plurality of clock signals respectively from the plurality of hosts;
generating time synchronization information by synchronizing time between the plurality of hosts and the storage device based on the plurality of clock signals; and
determining respective priorities of the plurality of submission queues based on the time synchronization information and the plurality of time limit information.

9. The method of claim 8, wherein generating the time synchronization information comprises synchronizing the time between the plurality of hosts and the storage device in a Time-Sensitive Network (TSN) method based on the plurality of clock signals.

10. The method of claim 8, wherein the time synchronization information comprises:
information about a plurality of latencies until the plurality of submission queues are respectively delivered from the plurality of hosts to the storage device, and
information about a plurality of time points at which the plurality of submission queues are respectively generated.

11. The method of claim 8, further comprising:
generating a plurality of completion queues respectively corresponding to the plurality of submission queues by processing the plurality of submission queues according to the respective priorities; and
transmitting the plurality of completion queues to corresponding hosts of the plurality of hosts.

12. The method of claim 11, wherein the plurality of submission queues and the plurality of completion queues comprise data packets according to Transmission Control Protocol (TCP)/Internet Protocol (IP).

13. The method of claim 11, wherein receiving the plurality of submission queues comprises receiving the plurality of submission queues through a Non-Volatile Memory Express (NVMe) interface, and
wherein transmitting the plurality of completion queues comprises transmitting the plurality of completion queues through the NVMe interface.

14. The method of claim 8, wherein the plurality of hosts comprise a first host, the plurality of submission queues comprise a first submission queue generated by the first host, and the first submission queue comprises first time limit information, and
wherein determining the respective priorities of the plurality of submission queues comprises:
determining, based on the time synchronization information, a first latency from a time point at which the first submission queue is generated to a time point at which the first submission queue is received by the storage device;
determining, based on the time synchronization information, a second latency from a time point at which a first completion queue corresponding to the first submission queue is generated to a time point at which the first completion queue is received by the first host; and
determining a priority of the first submission queue based on a first processing time period that is a difference between a first time limit indicated by the first time limit information, and
a sum of the first latency and the second latency.

15. A system comprising:
a first host configured to generate a first submission queue comprising:
a first command, and
first time limit information indicating a first processing time limit for the first command;
a second host configured to generate a second submission queue comprising:
a second command, and
second time limit information indicating a second processing time limit for the second command; and
a storage device comprising:
a host interface configured to receive:
the first submission queue and a first clock signal from the first host, and
the second submission queue and a second clock signal from the second host; and
a memory controller configured to:
generate time synchronization information by synchronizing time between the first host, the second host, and the storage device based on the first clock signal and the second clock signal,
determine a first priority of the first submission queue and a second priority of the second submission queue based on the time synchronization information, the first time limit information, and the second time limit information, and
process the first submission queue and the second submission queue in an order that is based on the first priority and the second priority.

16. The system of claim 15, wherein the memory controller is configured to synchronize the time between the first host, the second host, and the storage device through a Time-Sensitive Network (TSN) method based on the first clock signal and the second clock signal.

17. The system of claim 15, wherein the host interface comprises a Non-Volatile Memory Express (NVMe) interface.

18. The system of claim 15, wherein the first submission queue and the second submission queue each comprise a data packet according to Transmission Control Protocol (TCP)/Internet Protocol (IP).

19. The system of claim 15, wherein the memory controller is configured to:
determine a first processing time period for processing of the first command and a second processing time period for processing of the second command, based on the time synchronization information; and
determine the first priority based on the first processing time period and the second priority based on the second processing time period,
wherein processing the first submission queue comprises generating a first completion queue and processing the second submission queue comprises generation a second completion queue,
wherein the first processing time period corresponds to a difference between (i) the first processing time limit and (ii) a first latency consumed for transmission and reception of the first submission queue and transmission and reception of the first completion queue, and wherein the second processing time period corresponds to a difference between (i) the second processing time limit and (ii) a second latency consumed for transmission and reception of the second submission queue and transmission and reception of the second completion queue.

20. The system of claim 15, wherein the system comprises a vehicle system.
